(19) United States
(12) Patent Application Publication
(10) Pub. No.: US 2026/0020618 A1
(43) Pub. Date: Jan. 22, 2026

(54) APPARATUS FOR GENERATING AEROSOL AND METHOD OF GENERATING AEROSOL

(71) Applicant: KT&G CORPORATION, Daejeon (KR)

(72) Inventor: Sang Won CHOI, Daejeon (KR)

(73) Assignee: KT&G CORPORATION, Daejeon (KR)

(21) Appl. No.: 19/262,712

(22) Filed: Jul. 8, 2025

(30) Foreign Application Priority Data
Jul. 19, 2024 (KR) 10-2024-0095462

(51) Int. Cl. A24F 40/57; A24D 1/20; A24F 40/20; A24F 40/46; H05B 6/10

(52) U.S. Cl. CPC A24F 40/57; A24D 1/20; A24F 40/46; H05B 6/108; A24F 40/20

(57) ABSTRACT

An apparatus for generating aerosol may include a housing in which an accommodation space is formed, a color determination unit configured to sense a color of any part of an aerosol-generating article inserted into the accommodation space, a first heater and a second heater configured to heat different parts of the aerosol-generating article, and a controller configured to control the heating of the first heater and the second heater based on the information transmitted by the color determination unit.

### CROSS-REFERENCE TO RELATED APPLICATION

This application claims the benefit of and priority to Korean Patent Application No. 10-2024-0095462, filed Jul. 19, 2024, the content of which is incorporated by reference in its entirety.

### BACKGROUND

### Technical Field

The present disclosure relates to an apparatus for generating aerosol and a method of generating aerosol.

### Related Art

Recently, there is an increasing demand for an alternative method of overcoming disadvantages of a common cigarette. For example, there is an increasing demand for a method of generating aerosol by heating an aerosol-forming substance within an aerosol-generating article including a medium, rather than by combustion of a cigarette to produce aerosol. Accordingly, research of a heating type aerosol-generating article or a heating type aerosol-generating apparatus is actively carried out.

The apparatus for generating aerosol is for extracting some components from a medium or a material through aerosol. The medium may include a material including various ingredients. The material included in the medium may be a flavor material including various ingredients. For example, the material included in the medium may include nicotine ingredients, herbal ingredients and/or coffee ingredients.

In order to provide the best sense of taste by heating the medium including various materials, it is very important to heat different types of aerosol-generating articles in the best heating pattern, but there is a problem in that it is difficult to accurately provide various heating patterns depending on the type of aerosol-generating article.

### SUMMARY

Various embodiments are directed to solving the aforementioned problems and other problems.

Various embodiments may determine the type of inserted aerosol-generating article and provide a different heating pattern depending on the type of aerosol-generating article.

Various embodiments may provide an apparatus for generating aerosol, which can minimize a change in aerosol at an early heating stage and a change in aerosol at a late heating stage.

An apparatus for generating aerosol according to an aspect of the present disclosure may include a housing in which an accommodation space is formed, a color determination unit configured to sense a color of any part of an aerosol-generating article inserted into the accommodation space, a first heater and a second heater configured to heat different parts of the aerosol-generating article, and a controller configured to control the heating of the first heater and the second heater based on the information transmitted by the color determination unit.

A method of generating aerosol according to an aspect of the present disclosure may include sensing a color of a part of the aerosol-generating article by using a color determination unit, setting heating patterns of a first heater and a second heater based on information transmitted by the color determination unit, and heating the aerosol-generating article in a set heating pattern.

Embodiments of the present disclosure can provide the apparatus for generating aerosol and the method of generating aerosol, which determine the type of inserted aerosol-generating article and provide a different heating pattern depending on the type of aerosol-generating article.

Specifically, the apparatus for generating aerosol according to an embodiment of the present disclosure can sense a color of an aerosol-generating article and heat the aerosol-generating article in various patterns by using the first heater and the second heater.

Furthermore, the apparatus for generating aerosol according to an embodiment of the present disclosure can minimize a change in aerosol at an early heating stage and a change in aerosol at a late heating stage.

### BRIEF DESCRIPTION OF THE DRAWINGS

FIG. 1 is a construction diagram of an apparatus for generating aerosol according to an embodiment of the present disclosure.

FIG. 2 is a diagram illustrating an aerosol-generating article that is applied to the apparatus for generating aerosol according to an embodiment of the present disclosure.

FIG. 3 is a block diagram of the apparatus for generating aerosol according to an embodiment of the present disclosure.

FIG. 4 is a cross-sectional view of a first color unit according to an embodiment of the present disclosure.

FIG. 5 is a construction diagram of an apparatus for generating aerosol according to a modified example of an embodiment of the present disclosure.

FIG. 6 is a construction diagram of an apparatus for generating aerosol according to a modified example of an embodiment of the present disclosure.

FIG. 7 is a flowchart illustrating a method of generating aerosol according to an embodiment of the present disclosure.

### DETAILED DESCRIPTION

Hereinafter, an apparatus for generating aerosol and a method of generating aerosol will be described in detail with reference to the accompanying drawings through various examples of embodiments.

Hereinafter, embodiments disclosed in this specification are described in detail with reference to the accompanying drawings. The same or similar component is assigned the same reference numeral regardless of its reference numeral, and a redundant description thereof is omitted.

It is to be noted that the suffixes of components used in the following description, such as a “module” and a “unit”, are assigned or interchangeable with each other by taking into consideration only the ease of writing this specification, but in themselves are not particularly given distinct meanings and roles.

Furthermore, in describing an embodiment disclosed in this specification, when it is determined that a detailed description of a related known technology may obscure the subject matter of an embodiment disclosed in this specification, the detailed description will be omitted. Furthermore, it is to be understood that the accompanying drawings are merely intended to make easily understood the embodiments disclosed in this specification, and the technical spirit disclosed in this specification is not restricted by the accompanying drawings and includes all changes, equivalents, and substitutions which fall within the spirit and technical scope of this specification.

Terms including ordinal numbers, such as a “first” and a “second”, may be used to describe various components, but the components are not restricted by the terms. The terms are used to only distinguish one component from the other components.

When it is described that one component is “connected” or “coupled” the other component, it should be understood that one component may be directly connected or coupled to the other component, but a third component may exist between the two components. In contrast, when it is described that one component is “directly connected” or “directly coupled” to the other component, it should be understood that a third component does not exist between the two components.

An expression of the singular number includes an expression of the plural number unless clearly defined otherwise in the context.

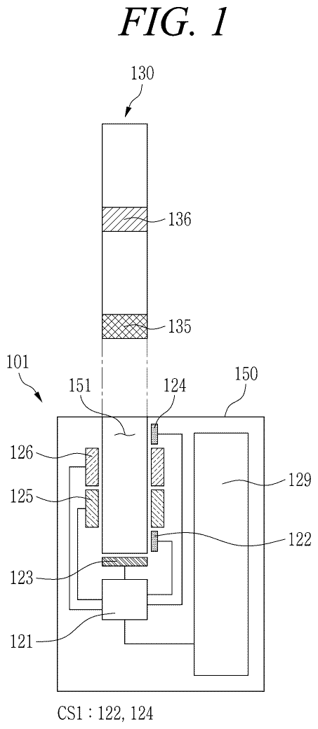

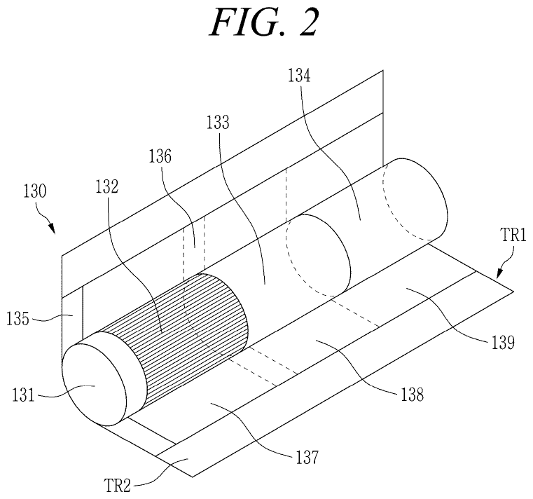

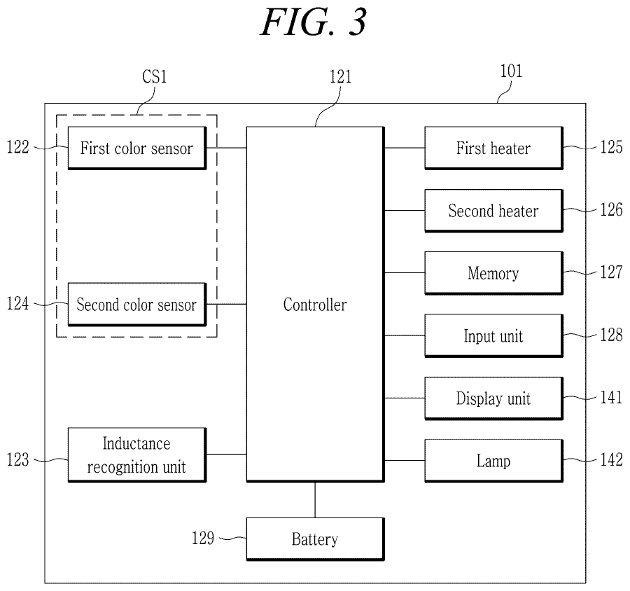

FIG. 1 is a construction diagram of an apparatus for generating aerosol according to an embodiment of the present disclosure. FIG. 2 is a diagram illustrating an aerosol-generating article that is applied to the apparatus for generating aerosol according to an embodiment of the present disclosure. FIG. 3 is a block diagram of the apparatus for generating aerosol according to an embodiment of the present disclosure.

Referring to FIGS. 1 to 3, an apparatus 101 for generating aerosol according to disclosed embodiments may include a housing 150, a first heater 125, a second heater 126, a color determination unit CS1, and a battery 129.

The housing 150 forms an appearance, and may have various shapes, such as a bar shape and a box shape. The battery 129, the controller 121, the first heater 125, the second heater 126, etc. may be disposed within the housing 150. An accommodation space 151 into which an aerosol-generating article 130 is inserted is formed in the housing 150. The accommodation space 151 may be placed in an upper part of the housing 150. A cover that opens and closes the accommodation space 151 may be installed in the housing 150.

The apparatus 101 for generating aerosol may further include the aerosol-generating article 130. As illustrated in FIG. 3, the aerosol-generating article 130 may have a stick having a cylindrical shape, but the present disclosure is not limited thereto. The aerosol-generating article 130 may include a material or a combination of two or more material which can generate aerosol and has any one of various states, such as a liquid state, a solid state, and a gel state.

The aerosol-generating article 130 may include a medium unit 132, a first segment 131, a second segment 133, a third segment 134, and a wrapper TR1, but this is exemplary. The aerosol-generating article 130 may be formed in various shapes, and the present disclosure is not limited to the structure of the aerosol-generating article 130.

The medium unit 132 may include at least one ingredient, among a granulated cigarette (cigarette granules), a reconstructed cigarette, and a cigarette stick. Furthermore, the medium unit 132 may further include an aerosol-generating material, such as glycerin. Furthermore, the medium unit 132 may further include other adding materials, such as flavors, wetting agents and/or organic acids. Furthermore, flavored fluids, such as menthol or a moisturizer, may be sprayed and added to the medium unit 132.

In an embodiment, the first segment 131 may include a cellulose acetate filter. Furthermore, the first segment 131 may include a paper filter and a porous molded article. For example, the length of the first segment 131 may be 4 to 15 mm, but the present disclosure is not limited thereto. Furthermore, the first segment 131 may include glycerin, menthol, or a flavor material in order to generate atomization. Furthermore, the first segment 131 may have a specific shape, such as a Y shape or an X shape, and may have a circular toe shape.

The second segment 133 and the third segment 134 may each have a cellulose acetate filter. Furthermore, the second segment 133 or the third segment 134 may include at least one scent capsule. Alternatively, the second segment 133 and the third segment 134 may each have a cellulose acetate filter in which a flavored material is mixed. For example, the second segment 133 or the third segment 134 may have a hollow filter. As another example, the third segment 134 may be omitted.

The wrapper TR1 may include first wrapping paper 137, second wrapping paper 138, third wrapping paper 139, a first color unit 135, a second color unit 136, and an outer skin TR2. At least one hole through which external air is introduced or an internal gas is drained may be formed in the wrapper TR1. The wrapper TR1 may include a material having high thermal conductivity.

The medium unit 132 may be packaged by the first wrapping paper 137. The second segment 133 may be packaged by the second wrapping paper 138. The third segment 134 may be packaged by the third wrapping paper 139. Furthermore, the first segment 131 may be packaged by the first color unit 135. A part of the second segment 133 may be packaged by the second color unit 136.

The entire aerosol-generating article 130 may be packaged again by the outer skin TR2. The outer skin TR2 may be manufactured by using sterile paper MFW, but the present disclosure is not limited thereto.

The first color unit 135 may be placed at the front end of the aerosol-generating article 130, and may be placed more at the front end of the aerosol-generating article 130 than the medium unit 132. The first color unit 135 may be placed between the first segment 131 and the outer skin TR2, but may be disposed outside the outer skin TR2.

If the first color unit 135 is placed within the outer skin TR2, a portion of the outer skin TR2 that surrounds the first color unit 135 may include a light-transmitting layer that transmits light. The light-transmitting layer may transmit 10% to 90% of light. The light-transmitting layer may be a single layer or a multi-layer, and specifically may be a multi-layer.

The light-transmitting layer may include one type or more selected from a group consisting of polyolefin, agar, and a cellulose-based material. In this case, when the light-transmitting layer includes all of polyolefin, agar, and the cellulose-based material, the light-transmitting layer may become transparent and temperature stability may also become excellent.

The light-transmitting layer may include a first layer including polyolefin, a second layer including agar, and a third layer including the cellulose-based material. For example, the first to third layers may be stacked to embody a stack film. Specifically, polyolefin may be polyethylene, polypropylene, or any one selected from a group consisting of combinations thereof. The cellulose-based material may be alpha-cellulose, beta-cellulose, or hydroxyalkyl cellulose.

The first color unit 135 may include metal, and may include a metal thin film and paper, for example. The metal thin film may include pure aluminum (AI) or an aluminum alloy, specifically pure aluminum.

The purity of pure aluminum may be 98% or more, or 99% or more. The aluminum alloy may further include one type of metal or more selected from a group consisting of copper (Cu), manganese (Mn), silicon (Si), magnesium (Mg), and zinc (Zn) in addition to aluminum.

In this case, aluminum content may be 50 wt % or more, 60 wt % or more, 70 wt % or more, 80 wt % or more, or 90 wt % or more on the basis of total wt of the aluminum alloy.

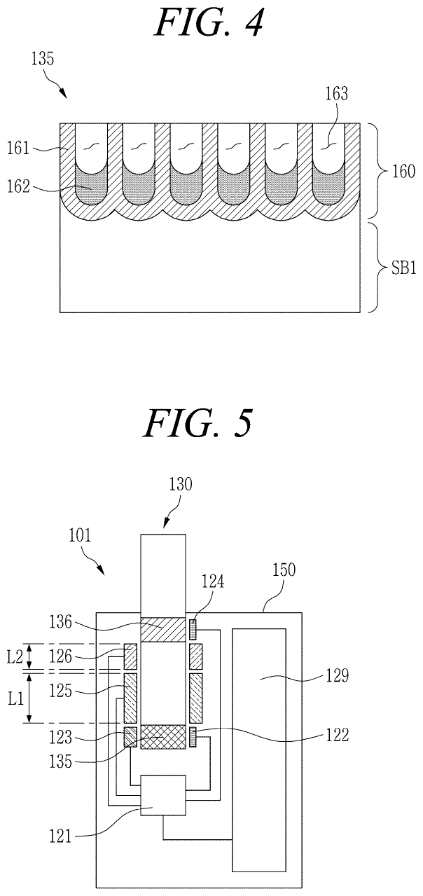

As illustrated in FIG. 4, an anodizing film 160 may be formed in the first color unit 135. The anodizing film 160 may have various colors, and may have colors, such as red, green, blue, yellow, and purple.

The anodizing film 160 may be formed by anodizing treatment. In this case, the anodizing treatment refers to a process in which metal is connected to a positive electrode and subjected to electrolysis in an electrolyte solution, thereby forming a thin oxide layer that adheres to the metal due to the oxygen generated at the positive electrode.

The anodizing film 160 may include a porous layer 161 formed on a metal thin film base SB1 and a sealing layer 162 formed on a porous layer 161. The sealing layer 162 may be formed by various methods, such as an organic sealing processing method. The base SB1 may include a metal thin film made of aluminum.

A plurality of fine voids 163 attributable to oxidization may be formed in the porous layer 161. The sealing layer 162 may be formed by a method of applying organic matters, such as synthetic resin, or immersing into the organic matters. The first color unit 135 may have various colors by the sealing layer 162.

The sealing layer 162 basically includes a color indication material, and may include any one of conductive polymer, a flavored material, and a flavored material anti-departure agent in addition to the color indication material. The void 163 may include a first void and a second void. The type of functional material that is deposited in the first void and the type of functional material that is deposited in the second void may be the same or different.

The sealing layer 162 may include conductive polymer. Accordingly, a reduction of electrical conductivity can be effectively prevented by the presence of the anodizing film 160.

The conductive polymer is not specially limited, and may include polymer having electrical conductivity of 1 S/cm or more, 10 S/cm or more, or 100 S/cm or more at 20° C., specifically polymer having electrical conductivity of 1 to 1000 S/cm. Specifically, the conductive polymer may include one type or more selected from a group consisting of polyacetylene, polyparaphenylene, polyparaphenylene sulfide, polythiophene, polypyrrole, polyparaphenylene vinylene, PEDOT-PSS(Poly(3,4-ethylenedioxythiophene)-polystyrene sulfonate), and polyaniline.

The weight-average molecular weight Mw of the conductive polymer is not specially limited, but may be specifically 1,000 to 500,000 g/mol, 1,000 to 100,000 g/mol, or 1,000 to 10,000 g/mol. In some examples, when the weight-average molecular weight of the conductive polymer satisfies the numerical range, the conductive polymer can better penetrate the void.

The sealing layer 162 may include a flavored material. Specifically, various feelings of satisfaction or smoking experiences may be assigned to a consumer because the flavored material is included in the void 163. When the aerosol-generating article is inserted into the apparatus for generating aerosol, the flavored material included in the wrapping paper for the aerosol-generating article may be evaporated and applied to the inside of the mouth of a consumer. The flavored material is not specially limited, but may specifically include menthol, natural vegetable fragrances, sugars, cocoa, and esters.

The second color unit 136 is disposed to be spaced apart from the first color unit 135 with the medium unit 132 interposed therebetween, and may be placed outside the second segment 133. The second color unit 136 may have a structure in which the color indication material is colored on the outer skin TR2. As another example, the second color unit 136 may also include an aluminum thin film in which an anodizing film is formed.

The color indication material is not specially limited, and may be a material that changes the color of the wrapping paper for the aerosol-generating article. Specifically, the color indication material may be any one selected from a group consisting of dyes, pigments, and mixtures thereof.

In some examples, the dyes are not specially limited, and may be dyes that are commercially used in a corresponding technical field. Specifically, the dyes may include disodium salt of ethyl [4-[p[ethyl (msulfobenzyl)amino]-α-(o-sulfophenyl)benzylidene]-2,5-cyclohexadien-1-ylidene](m-sulfobenzyl)ammonium hydroxide inner salt), disodium salt of 6-hydroxy-5-[(2-methyl-4-sulfophenyl)azo]-2-naphthalenesulfonic acid) or mixtures thereof.

In some examples, the pigments are not specially limited, and may be any one selected from a group consisting of organic pigments, inorganic pigments, and mixtures thereof. In some other examples, the pigments may include thermo-time pigments the color of which is changed depending on a temperature change.

In some examples, the pigments may include at least one of bis(dimethylammonium)tetrachloronickelate, bis(diethylammonium) tetrachlorocuprate, vanadium dioxide, and nickel sulfate.

The first heater 125, the second heater 126, the color determination unit CS1, an inductance recognition unit 123, the battery 129, and a controller 121 may be installed within the housing 150. A display unit 141, an input unit 128, and a lamp 142 may be installed outside the housing.

The display unit 141 may indicate the amount of remaining battery power, a heating mode, and the state of a device. The lamp 142 may include an LED, and may indicate a heating state in color.

The input unit 128 may receive information from a user, and may be a key pad, a dome switch, a touch pad, a jog wheel, or a jog switch, for example, but the present disclosure is not limited thereto. A user may manually set a heating pattern by using the input unit 128.

The apparatus 101 for generating aerosol may include the first heater 125 and the second heater 126. The first heater 125 and the second heater 126 may be placed outside the aerosol-generating article 130, and may heat the aerosol-generating article 130. The first heater 125 and the second heater 126 may each have a pipe form including a hollow, and may have a curved surface that faces the outer circumferential surface of the aerosol-generating article 130 and that surrounds the aerosol-generating article.

For example, the first heater 125 and the second heater 126 may each be an electrical resistance heater. For example, the first heater 125 and the second heater 126 each include an electrically conductive track. The first heater 125 and the second heater 126 may each be heated as a current flows into the electrically conductive track.

As another example, the first heater 125 and the second heater 126 may each include an induction coil and a heating body that is heated by the induction coil. Specifically, the first heater 125 and the second heater 126 may each be heated by a magnetic field that is generated by an alternating current that flows through the induction coil.

As illustrated in FIG. 1, the first heater 125 and the second heater 126 may be installed to surround the outer circumferential surface of the aerosol-generating article 130, and may heat the outer circumferential surface of the aerosol-generating article 130. The first heater 125 and the second heater 126 heat different parts of the aerosol-generating article 130, but may be formed to have the same length.

As another example, as illustrated in FIG. 5, the first heater 125 and the second heater 126 are disposed to be adjacent to the outer circumferential surface of the aerosol-generating article 130. The lengths (i.e., parts that are connected in the length direction of the aerosol-generating article) of the first heater 125 and the second heater 126 may be different.

A first length L1 of the first heater 125, which is connected in the length direction of the aerosol-generating article 130, may be longer than a second length L2 of the second heater 126, which is connected in the length direction of the aerosol-generating article 130. In this case, the first length L1 may be 1.2 times to 3 times the second length L2. If the first length L1 is longer than the second length L2, the first heater 125 may become a main heater and can rapidly heat the aerosol-generating article 130. The second heater 126 may be an auxiliary heater, and can precisely control a temperature of the aerosol-generating article 130.

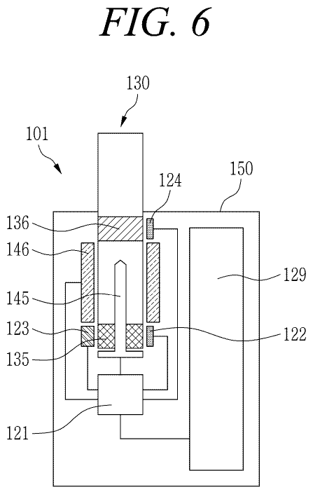

As another example, as illustrated in FIG. 6, the first heater 125 includes a heating pole that is inserted into the aerosol-generating article 130. The second heater 126 may be installed to heat the outer circumferential surface of the aerosol-generating article 130. When the first heater 125 is inserted into the aerosol-generating article 130 and the second heater 126 is installed to surround the outer circumferential surface of the aerosol-generating article, the aerosol-generating article 130 can be rapidly heated and a temperature of the aerosol-generating article 130 can be adjusted more easily.

The battery 129 may supply power that is necessary for the apparatus 101 for generating aerosol to operate. For example, the battery 129 may supply a current to the first heater 125, the second heater 126, the controller 121, and various sensors.

A cartridge may be installed within the housing 150. The cartridge may contain an aerosol-forming material having any one state of a liquid state, a solid state, a gaseous state, or a gel state.

For example, a liquid composition may be a liquid including a tobacco-containing material containing volatile tobacco-flavored ingredients, and may be a liquid including a non-cigarette material.

For example, the cartridge may be formed integrally with a case or may be detachably combined with the case. The cartridge may be connected to the accommodation space 151 through a channel.

As another example, a moisture sensor may be installed within the housing 150. The moisture sensor may measure the humidity of the aerosol-generating article 130. The location of the moisture sensor is not specially limited, and may be a location that is within the apparatus 101 for generating aerosol and at which the humidity of the aerosol-generating article 130 may be measured.

The moisture sensor is not specially limited, and may be various devices that measure moisture. Specifically, the moisture sensor may be a moisture measuring device using near-infrared spectrometry, which radiates a near-infrared wavelength having high affinity with moisture to the aerosol-generating article 130 and then measures moisture by securing a radiated beam.

The inductance recognition unit 123 recognizes an inductance change according to the insertion of the aerosol-generating article 130 and transmits a corresponding signal to the controller 121. As illustrated in FIG. 1, the inductance recognition unit 123 may be spaced apart from the front end of the aerosol-generating article 130, and may be disposed to face the front end of the aerosol-generating article 130.

When the aerosol-generating article 130 is inserted into the apparatus 101 for generating aerosol, an induced electro-motive force may be generated because the size and direction of a magnetic field or a current are changed due to the presence of the first color unit 135 including metal and the conductive polymer. Inductance refers to the ratio of the flux of a magnetic force to a current. Different inductance may be determined depending on the type of conductive polymer. An operating condition for the aerosol-generating article 130 may be determined based on the determined inductance.

As another example, as illustrated in FIG. 5, the inductance recognition unit 123 may be disposed to face the outer circumferential surface of the first color unit 135. The inductance recognition unit 123 and the first color sensor 122 may be spaced apart from each other with the aerosol-generating article 130 interposed therebetween. As another example, the first color sensor 122 may be fixed to the inductance recognition unit 123 or may be formed integrally with the inductance recognition unit 123.

When the aerosol-generating article 130 is inserted, an inductance change occurs due to the first color unit 135 including metal. The inductance recognition unit 123 recognizes the inductance change and transmits a signal related to the recognized inductance change to the controller 121.

When the signal is received from the inductance recognition unit 123, the controller 121 may determine that the aerosol-generating article 130 has been inserted, may turn on power, and may control the color determination unit CS1 to measure a color.

The color determination unit CS1 may include the first color sensor 122 and the second color sensor 124, but the present disclosure is not limited thereto. The color determination unit CS1 may include only one color sensor.

The first color sensor 122 senses a color of the first color unit 135, and determines that the color of the first color unit 135 corresponds to any one of preset colors by measuring the RGB value of the first color unit 135.

The second color sensor 124 senses a color of the second color unit 136, and determines that the color of the second color unit 136 corresponds to any one of the preset colors by measuring the RGB value of the second color unit 136.

The memory 127 stores preset heating patterns, and may store a plurality of heating patterns that are matched with information transmitted by the first color sensor 122 and the second color sensor 124. The heating patterns may include heating patterns of the first heater 125 and the second heater 126.

In the present disclosure, the controller 121 controls an overall operation of the apparatus 101 for generating aerosol. Specifically, the controller 121 controls operations of other components included in the apparatus 101 for generating aerosol, in addition to the battery 129, the first heater 125, the second heater 126, and the inductance recognition unit 123.

The controller 121 controls the first heater 125 and the second heater 126 in corresponding heating patterns by searching for the corresponding heating patterns according to colors designated in the heating patterns stored in the memory 127 based on the information transmitted by the first color sensor 122 and the second color sensor 124.

The controller 121 may control initial heating temperatures of the first heater 125 and the second heater 126 for a preset initial heating time based on information transmitted by the first color sensor 122, and may control re-heating temperatures of the first heater 125 and the second heater 126 for a preset re-heating time based on information transmitted by the second color sensor 124. In this case, the initial heating time may be 30 seconds to 50 seconds, and the re-heating time may be 15 seconds to 25 seconds after the initial heating time.

As another example, the controller 121 may heat the first heater 125 or the second heater 126 in a preset initial heating temperature range based on information transmitted by the first color sensor 122, and may heat the first heater 125 or the second heater 126 in a preset re-heating temperature range after a preset re-heating puff number. In this case, the re-heating puff number may be 5 times to 9 times. To this end, a puff sensor may be installed within the housing 150.

As another example, the controller 121 may heat the first heater 125 in an initial heating temperature range based on information transmitted by the first color sensor 122, and may heat the first heater 125 and the second heater 126 in a re-heating temperature range based on information transmitted by the second color sensor 124 after a re-heating puff number.

As another example, the controller 121 may heat the first heater 125 and the second heater 126 in an initial heating temperature range based on information transmitted by the first color sensor 122, may stop the heating after a re-heating puff number, and may then heat only the first heater 125 in a re-heating temperature range based on information transmitted by the second color sensor 124.

As another example, the controller 121 may control the heating of the first heater 125 based on information transmitted by the first color sensor 122, and may control the heating of the second heater 126 based on information transmitted by the second color sensor 124.

Specifically, when the first color sensor 122 senses a first color, the controller 121 may heat the first heater 125 and the second heater 126 in a first temperature range. When the first color sensor 122 senses a second color, the controller 121 may heat the first heater 125 and the second heater 126 in a second temperature range lower than the first temperature range. Furthermore, when the first color sensor 122 senses a third color, the controller 121 may heat the first heater 125 and the second heater 126 in a third temperature range lower than the second temperature range.

In this case, the first color may be red, the second color may be blue, and the third color may be green, but the present disclosure is not limited thereto. The colors may be variously set. Furthermore, when the first color sensor 122 senses white, the controller 121 may heat the first heater 125 and the second heater 126 at a maximum temperature.

The first temperature range may be 190° C. to 220° C. The second temperature range may be 160° C. to 190° C. The third temperature range may be 130° C. to 160° C. The maximum temperature may be 170° C. or more.

As another example, the controller 121 may heat the first heater 125 and the second heater 126 for a preset initial heating time, may cool the first heater 125 and the second heater 126 for a cooling time, may heat the first heater 125 and the second heater 126 at a temperature that is 60° C. to 80° C. lower than the highest temperature, and may then stop the heating. In this case, the initial heating time may be 30 seconds to 50 seconds, and the cooling time may be 15 seconds to 25 seconds.

As another example, when the second color sensor 124 senses the first color, the controller 121 may heat only the first heater 125 at a first re-heating temperature after a preset puff number. When the second color sensor 124 senses the second color, the controller 121 may heat only the first heater 125 at a second re-heating temperature. When the second color sensor 124 senses the third color, the controller 121 may stop the heating of the first heater 125.

In this case, the first re-heating temperature may be 180° C. to 200° C., and the second re-heating temperature may be 150° C. to 170° C. The controller 121 re-heats the first heater 125 for only a re-heating time. In this case, the re-heating time may be 25 seconds to 35 seconds.

When a user manually changes a heating pattern, the controller 121 may control the first heater 125 and the second heater 126 in a heating pattern designated by the user.

As described above, according to embodiments of the present disclosure, heating patterns having various combinations can be realized by using the first color sensor 122 and the second color sensor 124. The best sense of taste can be provided to a user. Furthermore, a difference between initial aerosol and post aerosol can be minimized by heating the aerosol-generating article 130 at a precise heating temperature according to a heating time by using the first heater 125 and the second heater 126.

Hereinafter, a method of generating aerosol according to an embodiment of the present disclosure is described.

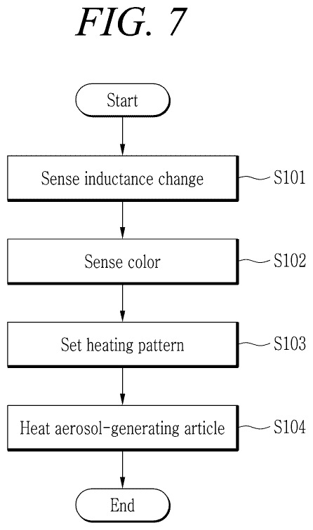

FIG. 7 is a flowchart illustrating a method of generating aerosol according to an embodiment of the present disclosure. The method of generating aerosol may be performed by the apparatus for generating aerosol described with reference to FIGS. 1 to 6. Contents related to the apparatus for generating aerosol described with reference to FIGS. 1 to 6 may also be applied to the method of generating aerosol in FIG. 7.

The method of generating aerosol according to the present embodiment may include step S101 of sensing an inductance change attributable to the insertion of the aerosol-generating article 130. Step S101 of sensing the inductance change includes recognizing an inductance change attributable to the insertion of the aerosol-generating article 130 and transmitting a corresponding signal to the controller. Step S101 of sensing the inductance change includes sensing an inductance change that occurs due to the first color unit 135 including metal when the aerosol-generating article is inserted.

The method of generating aerosol according to the present embodiment may include step S102 of sensing a color, wherein a color of some part of the aerosol-generating article is sensed by using the color determination unit CS1. Step S102 of sensing the color may include determining colors at different locations of the aerosol-generating article by using the two color sensors 122 and 124. For example, step S102 of sensing the color may include determining a color of the first color unit 135 at the front end of the aerosol-generating article 130 by using the first color sensor 122, and may include determining a color of the second color unit 136 spaced apart from the first color unit 135 with the medium unit 132 interposed therebetween by using the second color sensor 124. Step S102 of sensing the color may include determining that a sensed color corresponds to any one of colors stored in the memory 127 and matching the sensed color with any one of the stored colors.

The method of generating aerosol according to the present embodiment may further include step S103 of setting a heating pattern of the heater based on information transmitted by the color determination unit CS1. Step S103 of setting the heating pattern includes setting a matched heating pattern by searching for a heating pattern stored in the memory 127 based on information transmitted in step S102 of sensing the color.

Step S103 of setting the heating pattern may include setting a matched heating pattern based on two pieces of color information transmitted by the first color sensor 122 and the second color sensor 124.

For example, step S103 of setting the heating pattern may include controlling initial heating temperatures of the first heater 125 and the second heater 126 based on information transmitted by the first color sensor 122 and setting re-heating temperatures of the first heater 125 or the second heater 126 based on information transmitted by the second color sensor 124.

As another example, step S103 of setting the heating pattern may include setting the heating temperature and time of the first heater 125 based on information transmitted by the first color sensor 122 and setting the heating temperature and time of the second heater 126 based on information transmitted by the second color sensor 124.

The method of generating aerosol according to the present embodiment may further include step S104 of heating the aerosol-generating article in a set heating pattern. Step S104 of heating the aerosol-generating article may include heating the aerosol-generating article 130 by using the first heater 125 and the second heater 126 and controlling the first heater 125 and the second heater 126 at different temperatures for different heating times.

Step S104 of heating the aerosol-generating article may include heating the first heater 125 and the second heater 126 in a preset initial heating temperature range and heating the first heater 125 or the second heater 126 in a preset re-heating temperature range after a preset re-heating puff number. In this case, the re-heating puff number may be 5 times to 9 times.

For example, step S104 of heating the aerosol-generating article may include heating the first heater 125 and the second heater 126 in an initial heating temperature range, stopping the heating after a re-heating puff number, and then heating only the first heater 125 in a re-heating temperature range.

As another example, step S104 of heating the aerosol-generating article may include heating only the first heater 125 in an initial heating temperature range and heating the first heater 125 and the second heater 126 in a re-heating temperature range after a re-heating puff number.

Furthermore, step S104 of heating the aerosol-generating article may include heating the first heater 125 and the second heater 126 for a preset initial heating time, cooling the first heater 125 and the second heater 126 for a cooling time, heating the first heater 125 and the second heater 126 at a temperature that is 60° C. to 80° C. lower than the highest temperature, and then stopping the heating. In this case, the initial heating time may be 30 seconds to 50 seconds, and the cooling time may be 15 seconds to 25 seconds.

The aforementioned some embodiments or other embodiments of the present disclosure are not exclusive or different from each other. The components or functions of the aforementioned some embodiments or other embodiments of the present disclosure may be jointly used or combined with each other.

For example, this refers to that a component A described in a specific embodiment and/or drawing and a component B described in another embodiment and/or drawing may be combined. That is, although a combination between components is not directly described, the components may be combined except a case in which the combination is described as being impossible.

The detailed description should not be construed as being limitative, but should be considered to be illustrative from all aspects. The scope of the present disclosure should be determined by reasonable analysis of the attached claims, and all changes within the equivalent scope of the present disclosure are included in the scope of the present disclosure.

What is claimed is:

1. An apparatus for generating aerosol, comprising:
a housing in which an accommodation space is formed;
a color determination unit configured to sense a color of any part of an aerosol-generating article inserted into the accommodation space;
a first heater and a second heater configured to heat different parts of the aerosol-generating article; and
a controller configured to control the heating of the first heater and the second heater based on the information transmitted by the color determination unit.

2. The apparatus of claim 1, wherein the color determination unit comprises:
a first color sensor configured to sense a color of any part of the aerosol-generating article, and
a second color sensor configured to sense a color of another part of the aerosol-generating article.

3. The apparatus of claim 2, wherein:
the first heater and the second heater are installed to heat an outer circumferential surface of the aerosol-generating article, and
lengths of the first heater and the second heater that are connected in a length direction of the aerosol-generating article are identical or different.

4. The apparatus of claim 3, wherein when the lengths of the first heater and the second heater are different, a first length of the first heater that is connected in the length direction of the aerosol-generating article is longer than a second length of the second heater that is connected in the length direction of the aerosol-generating article.

5. The apparatus of claim 2, wherein:
the first heater comprises a heating pole inserted into the aerosol-generating article, and
the second heater is installed to heat an outer circumferential surface of the aerosol-generating article.

6. The apparatus of claim 2, wherein the controller is configured to control an initial heating temperature of the first heater or the second heater for a preset initial heating time based on information transmitted by the first color sensor and to control a re-heating temperature of the first heater or the second heater for a preset re-heating time after the initial heating time based on information transmitted by the second color sensor.

7. The apparatus of claim 2, wherein the controller is configured to control an initial heating temperature of the first heater or the second heater based on information transmitted by the first color sensor and to control a re-heating temperature of the first heater or the second heater after a preset re-heating puff number based on information transmitted by the second color sensor.

8. The apparatus of claim 2, wherein the controller is configured to control the heating of the first heater based on information transmitted by the first color sensor and to control the heating of the second heater based on information transmitted by the second color sensor.

9. The apparatus of claim 2, wherein the controller is configured to control the first heater and the second heater in a preset first temperature range when the first color sensor senses a first color and to control the first heater and the second heater in a second temperature range lower than the first temperature range when the first color sensor senses a second color.

10. The apparatus of claim 2, wherein the controller is configured to control the first heater a first re-heating temperature after a preset puff number when the second color sensor senses a first color and to control the first heater at a second re-heating temperature lower than the first re-heating temperature when the second color sensor senses a second color.

11. The apparatus of claim 2, further comprising an aerosol-generating article inserted into the accommodation space,
wherein any one part formed in the aerosol-generating article comprises a metal thin film in which an anodizing film is formed,
the anodizing film comprises a porous layer formed on a base and a sealing layer formed on the porous layer, and
the sealing layer comprises a color indication material.

12. A method of generating aerosol, comprising:
sensing a color of a part of the aerosol-generating article by using a color determination unit;
setting heating patterns of a first heater and a second heater based on information transmitted by the color determination unit; and
heating the aerosol-generating article in a set heating pattern.

13. The method of claim 12, wherein the setting of the heating patterns comprises:
controlling initial heating temperatures of the first heater and the second heater based on information transmitted by a first color sensor of the color determination unit, and
setting a re-heating temperature of the first heater or the second heater based on information transmitted by a second color sensor of the color determination unit.

14. The method of claim 12, wherein the setting of the heating patterns comprises:
setting a heating temperature and time of the first heater based on information transmitted by a first color sensor of the color determination unit, and
setting a heating temperature and time of the second heater based on information transmitted by a second color sensor of the color determination unit.

15. The method of claim 12, wherein the heating of the aerosol-generating article comprises:
controlling initial heating temperatures of the first heater and the second heater based on information transmitted by a first color sensor of the color determination unit, and
controlling a re-heating temperature of the first heater or the second heater after a preset re-heating puff number based on information transmitted by a second color sensor of the color determination unit.
